(19) United States
(12) Patent Application Publication
(10) Pub. No.: US 2011/0290209 A1
(43) Pub. Date: Dec. 1, 2011

(54) STABILIZED POLYAMIDES

(75) Inventors: Philippe Desbois, Edingen-Neckarhausen (DE); Martin Klatt, Mannheim (DE); Sachin Jain, Mannheim (DE)

(73) Assignee: BASF SE, Ludwigshafen (DE)

(21) Appl. No.: 13/128,502

(22) PCT Filed: Oct. 29, 2009
(86) PCT No.: PCT/EP09/64250

§ 371 Date: Aug. 9, 2011

(30) Foreign Application Priority Data
Nov. 11, 2008 (EP) 08168798.0

(51) Int. Cl. F02M 35/104; C08L 79/02; C08L 77/00; C08K 5/3465; C08K 13/02

(52) U.S. Cl. 123/184.61; 524/89

(57) ABSTRACT

Thermoplastic molding compositions comprising
A) from 10 to 98.7% by weight of at least one thermoplastic polyamide having a viscosity number (VN) to ISO 307 of at least 150 ml/g,
B) from 1 ppm to 0.95% by weight of at least one polyethyleneimine homo- or copolymer,
C) from 0.05 to 3% by weight of a lubricant,
D) from 0.05 to 3% by weight of a copper-containing stabilizer,
E) from 1 to 50% by weight of a fibrous or particulate filler, or mixtures thereof,
F) from 0.1 to 5% by weight of a nigrosine,
G) from 0 to 30% by weight of further additives,
   the sum of components A) to G) adding up to 100%.

The invention relates to thermoplastic molding compositions comprising
A) from 10 to 98.7% by weight of at least one thermoplastic polyamide having a viscosity number (VN) to ISO 307 of at least 150 ml/g,
B) from 1 ppm to 0.95% by weight of at least one polyethyleneimine homo- or copolymer,
C) from 0.05 to 3% by weight of a lubricant,
D) from 0.05 to 3% by weight of a copper-containing stabilizer,
E) from 1 to 50% by weight of a fibrous or particulate filler, or mixtures thereof,
F) from 0.05 to 5% by weight of a nigrosine,
G) from 0 to 30% by weight of further additives,
   the sum of components A) to G) adding up to 100%.

The invention further relates to the use of the inventive molding compositions for producing fibers, films and moldings of any type, and also to the moldings obtainable in this way, in particular intake tubes (intake manifolds) for the automotive sector.

Thermoplastic polyamides such as PA6 and PA66 are frequently used in the form of glass fiber-reinforced molding compositions as construction materials for components which are exposed to elevated temperatures during their lifetime, which results in thermooxidative damage. Addition of known thermal stabilizers can delay the occurrence of the thermooxidative damage but not prevent it permanently, which is manifested, for example, in a decline in the mechanical characteristic values. The improvement of the thermal aging resistance of polyamides is entirely desirable, since this can achieve longer lifetimes for thermally stressed components, and can lower their risk of failure. Alternatively, an improved thermal aging resistance can also enable the use of the components at higher temperatures.

Kunststoff Handbuch [Plastics Handbook], 3. Technische Thermoplaste [Industrial Thermoplastics], 4. Polyamide [Polyamides], 1998 Carl Hanser Verlag, Munich, Vienna, editors L. Bottenbruch, R. Binsack discloses the use of various thermal stabilizers in polyamides.

The use of hyperbranched polyethyleneimines in thermoplastic polymers is known, for example, from DE-A 10030553. Examples are given there only for unreinforced polyoxymethylene molding compositions, which improves the stability of diesel fuel.

EP-A 1065236 discloses unreinforced polyamides in which polyethyleneimines and oligocarboxylic acids are used during the polymerization. The molding compositions described have improved solvent resistance, but the thermal aging stability is in need of improvement.

DE 102005005847 discloses stabilized polyamides which comprise polyethyleneimines and stabilizers. However, the weld line strength of the molding materials is still in need of improvement.

It was therefore an object of the present invention to provide stabilized polyamide molding compositions which have increased thermal stability and a better weld line strength. The processing properties should likewise be improved.

Accordingly, the molding compositions defined at the outset have been found. Preferred embodiments can be taken from the subclaims.

As component A), the inventive molding compositions comprise from 10 to 98.7% by weight, preferably from 20 to 89.6% by weight and in particular from 30 to 85% by weight, of at least one polyamide.

The polyamides of the inventive molding compositions have a viscosity number of at least 150 ml/g, determined in a 0.5% by weight solution in 96% by weight sulfuric acid at 25° C. to ISO 307.

Preference is given to semicrystalline or amorphous resins having a molecular weight (weight-average) of at least 5000, as described, for example, in the U.S. Pat. Nos. 2,071,250, 2,071,251, 2,130,523, 2,130,948, 2,241,322, 2,312,966, 2,512,606 and 3,393,210.

Examples thereof are polyamides which derive from lactams having from 7 to 13 ring members, such as polycaprolactam, polycaprylolactam and polylaurolactam, and also polyamides which are obtained by reacting dicarboxylic acids with diamines.

Dicarboxylic acids which can be used are alkanedicarboxylic acids having from 6 to 12 carbon atoms, in particular from 6 to 10 carbon atoms, and aromatic dicarboxylic acids. A few acids which should be mentioned here are adipic acid, azelaic acid, sebacic acid, dodecanedioic acid and terephthalic and/or isophthalic acid.

Particularly suitable diamines are alkanediamines having from 6 to 12 carbon atoms, in particular from 6 to 8 carbon atoms, or else m-xylylenediamine, di(4-aminophenyl)-methane, di(4-aminocyclohexyl)methane, 2,2-di(4-aminophenyl)propane, 2,2-di(4-aminocyclohexyl)propane or 1,5-diamino-2-methylpentane. Preferred polyamides are polyhexamethyleneadipamide, polyhexamethylene-sebacamide and polycaprolactam, and also nylon-6/6,6, in particular with a proportion of from 5 to 95% by weight of caprolactam units.

Further suitable polyamides are obtainable from w-aminoalkyl nitriles, for example aminocapronitrile (PA 6) and adipodinitrile with hexamethylenediamine (PA 66) by what is known as direct polymerization in the presence of water, as described, for example, in DE-A 10313681, EP-A 1198491 and EP 922065.

Mention should also, be made of polyamides which are obtainable, for example, by condensing 1,4-diaminobutane with adipic acid at elevated temperature (nylon-4,6). Preparation processes for polyamides of this structure are described, for example, in EP-A 38 094, EP-A 38 582 and EP-A 39 524.

Further suitable polyamides are those which are obtainable by copolymerizing two or more of the monomers mentioned above, or mixtures of a plurality of polyamides are also suitable, the mixing ratio being as desired.

Further copolyamides which have been found to be particularly advantageous are partially aromatic copolyamides such as PA 6/6T and PA 66/6T, whose triamine content is less than 0.5% by weight, preferably less than 0.3% by weight (see EP-A 299 444).

The preferred partially aromatic copolyamides with low triamine content can be prepared by the processes described in EP-A 129 195 and 129 196.

The list below is not comprehensive, but comprises the polyamides A) mentioned, and also other polyamides A) in the sense of the invention and the monomers present.

### AB Polymers:

PA 4 pyrrolidone
PA 6 e-caprolactam
PA 7 ethanolactam
PA 8 caprylolactam
PA 9 9-aminopelargonic acid
PA 11 11-aminoundecanoic acid
PA 12 laurolactam

### AA/BB Polymers:

PA 46 tetramethylenediamine, adipic acid
PA 66 hexamethylenediamine, adipic acid
PA 69 hexamethylenediamine, azelaic acid
PA 610 hexamethylenediamine, sebacic acid
PA 612 hexamethylenediamine, decanedicarboxylic acid
PA 613 hexamethylenediamine, undecanedicarboxylic acid
PA 1212 1,12-dodecanediamine, decanedicarboxylic acid
PA 1313 1,13-diaminotridecane, undecanedicarboxylic acid
PA 6T hexamethylenediamine, terephthalic acid
PA MXD6 m-xylylenediamine, adipic acid

### AA/BB Polymers

PA 6I hexamethylenediamine, isophthalic acid
PA 6-3-T trimethylhexamethylenediamine, terephthalic acid

### PA 6/6T (see PA 6 and PA 6T)

### PA 6/66 (see PA 6 and PA 66)

### PA 6/12 (see PA 6 and PA 12)

### PA 66/6/610 (see PA 66, PA 6 and PA 610)

### PA 6I/6T (see PA 61 and PA 6T)

PA PACM 12 diaminodicyclohexylmethane, laurolactam
PA 6I/6T/PACM as PA 61/6T+diaminodicyclohexylmethane
PA 12/MACMI laurolactam, dimethyldiaminodicyclohexylmethane, isophthalic acid
PA 12/MACMT laurolactam, dimethyldiaminodicyclohexylmethane, terephthalic acid
PA PDA-T phenylenediamine, terephthalic acid

As component B), the thermoplastic molding compositions comprise, in accordance with the invention, from 1 ppm to 0.95% by weight of at least one polyethyleneimine homopolymer or copolymer. The proportion of B) is preferably from 0.01 to 0.8% by weight and in particular from 0.1 to 0.6% by weight based on A) to G), preference being given to branched polyethyleneimines.

In the context of the present invention, polyethyleneimines are understood to be both homo- and copolymers which are obtainable, for example, by the processes in Ullmann Electronic Release under the keyword “aziridines” or according to WO-A 94/12560.

The homopolymers are generally obtainable by polymerization of ethyleneimine (aziridine) in aqueous or organic solution in the presence of acid-eliminating compounds, acids or Lewis acids. Such homopolymers are branched polymers which generally comprise primary, secondary and tertiary amino groups in a ratio of approx. 30% to 40% to 30%. The distribution of the amino groups can generally be determined by means of ¹³C NMR spectroscopy. It is preferably from 1/0.7-1.4/0.3-1.1 to 1/0.8-1.3/0.5-0.9.

The comonomers used are preferably compounds which have at least two amino functions. Examples of suitable comonomers include alkylenediamines having from 2 to 10 carbon atoms in the alkylene radical, preference being given to ethylenediamine and propylenediamine. Further suitable comonomers are diethylenetriamine, triethylenetetramine, tetraethylenepentamine, dipropylenetriamine, tripropylene-tetramine, dihexamethylenetriamine, aminopropylethylenediamine and bisaminopropylethylenediamine.

Polyethyleneimines typically have an average molecular weight (weight-average) of from 100 to 3 000 000, preferably from 800 to 2 000 000 (determined by means of light scattering). The preferred M_{w} is from 700 to 1 500 000, especially from 1000 to 500 000.

Additionally suitable are crosslinked polyethyleneimines which are obtainable by reaction of polyethyleneimines with bi- or polyfunctional crosslinkers which have, as a functional group, at least one halohydrin, glycidyl, aziridine or isocyanate unit or a halogen atom. Examples include epichlorohydrin or bischlorohydrin ethers of polyalkylene glycols having from 2 to 100 ethylene oxide and/or propylene oxide units, and also the compounds listed in DE-A 19 93 17 20 and U.S. Pat. No. 4,144,123. Processes for preparing crosslinked polyethyleneimines are known, inter alia, from the abovementioned documents and also EP-A 895 521 and EP-A 25 515.

Also suitable are grafted polyethyleneimines, in which the grafting agents used may be all compounds which can react with the amino or imino groups of the polyethyleneimines. Suitable grafting agents and processes for preparing grafted polyethyleneimines can be taken, for example, from EP-A 675 914.

Equally suitable polyethyleneimines in the context of the invention are amidated polymers which are typically obtainable by reacting polyethyleneimines with carboxylic acids, their esters or anhydrides, carboxamides or carbonyl halides. Depending on the proportion of amidated nitrogen atoms in the polyethyleneimine chain, the amidated polymers may subsequently be crosslinked with the crosslinkers mentioned. Preference is given to amidating up to 30% of the amino functions, so that sufficient primary and/or secondary nitrogen atoms are still available for a subsequent crosslinking reaction.

Also suitable are alkoxylated polyethyleneimines which are obtainable, for example, by reaction of polyethyleneimine with ethylene oxide and/or propylene oxide. Such alkoxylated polymers too are subsequently crosslinkable.

Further suitable inventive polyethyleneimines include hydroxyl-containing polyethylene-imines and amphoteric polyethyleneimines (incorporation of anionic groups), and also lipophilic polyethyleneimines which are generally obtained by incorporation of long-chain hydrocarbon radicals into the polymer chain. Processes for preparing such polyethyleneimines are known to those skilled in the art, so that further details on this subject are unnecessary.

As component C), the inventive molding compositions comprise from 0.05 to 3% by weight, preferably from 0.1 to 1.5% by weight and in particular from 0.1 to 1% by weight, of a lubricant.

Preference is given to aluminum salts, alkali metal salts, alkaline earth metal salts or esters or amides, of fatty acids having from 10 to 44 carbon atoms, preferably having from 12 to 44 carbon atoms.

The metal ions are preferably alkaline earth metal and Al, particular preference being given to Ca or Mg.

Preferred metal salts are calcium stearate and calcium montanate, and also aluminum stearate.

It is also possible to use mixtures of different salts, in which case the mixing ratio is as desired.

The carboxylic acids may be mono- or dibasic. Examples include pelargonic acid, palmitic acid, lauric acid, margaric acid, dodecanedioic acid, behenic acid, and more preferably stearic acid, capric acid and montanic acid (mixture of fatty acids having from 30 to 40 carbon atoms).

The aliphatic alcohols may be mono- to tetrahydric. Examples of alcohols are n-butanol, n-octanol, stearyl alcohol, ethylene glycol, propylene glycol, neopentyl glycol, pentaerythritol, preference being given to glycerol and pentaerythritol.

The aliphatic amines may be mono- to trifunctional. Examples thereof are stearylamine, ethylenediamine, propylenediamine, hexamethylenediamine, di(6-aminohexyl)amine, particular preference being given to ethylenediamine and hexamethylenediamine. Preferred esters or amides are correspondingly glyceryl distearate, glyceryl tristearate, ethylenediamine distearate, glyceryl monopalmitate, glyceryl trilaurate, glyceryl monobehenate and pentaerythrityl tetrastearate.

It is also possible to use mixtures of different esters or amides, or esters in combination with amides, in which case the mixing ratio is as desired.

As component D), the inventive molding compositions comprise from 0.05 to 3% by weight, preferably from 0.1 to 1.5% by weight and in particular from 0.1 to 1% by weight, of a copper stabilizer, preferably of a copper(I) halide, in particular in a mixture with an alkali metal halide, preferably KI, in particular in a ratio of 1:4.

Suitable salts of monovalent copper are copper(I) acetate, copper(I) chloride, bromide and iodide. They are comprised in amounts of from 5 to 500 ppm of copper, preferably from 10 to 250 ppm, based on polyamide.

The advantageous properties are obtained in particular when the copper is present in molecular distribution in the polyamide. This is achieved when a concentrate which comprises polyamide, a salt of monovalent copper and an alkali halide in the form of a solid, homogeneous solution is added to the molding composition. A typical concentrate consists, for example, of from 79 to 95% by weight of polyamide and from 21 to 5% by weight of a mixture of copper iodide or bromide and potassium iodide. The concentration of copper in the solid homogeneous solution is preferably between 0.3 and 3% by weight, in particular between 0.5 and 2% by weight, based on the total weight of the solution, and the molar ratio of copper(I) iodide to potassium iodide is between 1 and 11.5, preferably between 1 and 5.

Suitable polyamides for the concentrate are homopolyamides and copolyamides, in particular nylon-6 and nylon-6,6.

Fibrous or particulate fillers E) include carbon fibers, glass fibers, glass beads, amorphous silica, calcium silicate, calcium metasilicate, magnesium carbonate, kaolin, chalk, powdered quartz, mica, barium sulfate and feldspar, which are used in amounts of from 1 to 50% by weight, in particular from 1 to 40% by weight, preferably from 10 to 90% by weight.

Preferred fibrous fillers include carbon fibers, aramid fibers and potassium titanate fibers, and particular preference is given to glass fibers in the form of E glass. These may be used in the form of rovings or in the commercially available forms of chopped glass.

The fibrous fillers may be surface-pretreated with a silane compound for better compatibility with the thermoplastic.

Suitable silane compounds are those of the general formula:

(X—(CH₂)ₙ)ₖ—Si—(O—CₘH₂ₘ₊₁)₄₋ₖ

in which the substituents are each defined as follows:

### X NH₂—,

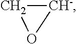

### HO—,

n is an integer from 2 to 10, preferably 3 to 4,
m is an integer from 1 to 5, preferably 1 to 2, and
k is an integer from 1 to 3, preferably 1.

Preferred silane compounds are aminopropyltrimethoxysilane, aminobutyltrimethoxy-silane, aminopropyltriethoxysilane and aminobutyltriethoxysilane, and also the corresponding silanes which comprise a glycidyl group as the substituent X.

The silane compounds are used for surface coating generally in amounts of from 0.01 to 2% by weight, preferably from 0.025 to 1.0% by weight and in particular from 0.05 to 0.5% by weight (based on E)).

Acicular mineral fillers are also suitable.

In the context of the invention, acicular mineral fillers are mineral fillers with strongly developed acicular character. An example is acicular wollastonite. The mineral preferably has an L/D (length to diameter) ratio of from 8:1 to 35:1, preferably from 8:1 to 11:1. The mineral filler may, if appropriate, be pretreated with the aforementioned silane compounds, but the pretreatment is not essential.

Further fillers include kaolin, calcined kaolin, wollastonite, talc and chalk, and also further platelet- or needle-like nanofillers, preferably in amounts between 0.1 and 10% by weight. For this purpose, preference is given to using boehmite, bentonite, montmorillonite, vermiculite, hectorite and laponite. In order to obtain good compatibility of the platelet-like nanofillers with the organic binder, the platelet-like nanofillers are organically modified according to the prior art. The addition of platelet-like or needle-like nanofillers to the inventive nanocomposites leads to a further increase in the mechanical strength.

As component F), the inventive molding compositions comprise from 0.05 to 5%, preferably from 0.1 to 2% and especially from 0.25 to 1% by weight of a nigrosine.

Nigrosines are generally understood to mean a group of black or gray phenazine dyes (azine dyes), which are related to the indolines, in various embodiments (water-soluble, fat-soluble, gasoline-soluble), which find use in wool dyeing and printing, in the black coloring of silks, for tanning of leather, shoe polishes, varnishes, plastics, baking varnishes, inks and the like, and also as microscopy dyes.

The nigrosines are obtained industrially by heating nitrobenzene, aniline and aniline hydrochloride with metallic iron and FeCl₃ (name derives from the Latin niger=black).

Component F) can be used as a free base or else as a salt (e.g. hydrochloride).

Further details regarding nigrosines can be taken, for example, from the electronic lexicon Römpp Online, Version 2.8, Thieme-Verlag Stuttgart, 2006, under “Nigrosine”.

As component G), the inventive molding compositions may comprise from 0 to 30% by weight, in particular up to 20% by weight, of further additives and processing assistants.

Further customary additives G) are, for example in amounts of up to 25% by weight, preferably up to 20% by weight, elastomeric polymers (also often referred to as impact modifiers, elastomers or rubbers).

In quite general terms, these are copolymers which have preferably been formed from at least two of the following monomers: ethylene, propylene, butadiene, isobutene, isoprene, chloroprene, vinyl acetate, styrene, acrylonitrile and acrylic and/or methacrylic esters having from 1 to 18 carbon atoms in the alcohol component.

Such polymers of this type are described, for example, in Houben-Weyl, Methoden der organischen Chemie [Methods of Organic Chemistry], Vol. 14/1 (Georg-Thieme-Verlag, Stuttgart, Germany, 1961), pages 392-406, and in the monograph by C. B. Bucknall, “Toughened Plastics” (Applied Science Publishers, London, UK, 1977).

Some preferred types of such elastomers are described below.

Preferred types of such elastomers are those known as ethylene-propylene (EPM) and ethylene-propylene-diene (EPDM) rubbers.

EPM rubbers generally have virtually no residual double bonds, whereas EPDM rubbers may have from 1 to 20 double bonds per 100 carbon atoms.

Examples of diene monomers for EPDM rubbers include conjugated dienes, such as isoprene and butadiene, nonconjugated dienes having from 5 to 25 carbon atoms, such as 1,4-pentadiene, 1,4-hexadiene, 1,5-hexadiene, 2,5-dimethyl-1,5-hexadiene and 1,4-octadiene, cyclic dienes such as cyclopentadiene, cyclohexadienes, cyclooctadienes and dicyclopentadiene, and also alkenylnorbornenes such as 5-ethylidene-2-norbornene, 5-butylidene-2-norbornene, 2-methallyl-5-norbornene and 2-isopropenyl-5-norbornene, and tricyclodienes such as 3-methyltricyclo[5.2.1.0^{2,6}]-3,8-decadiene, or mixtures thereof. Preference is given to 1,5-hexadiene, 5-ethylidenenorbornene and dicyclopentadiene. The diene content of the EPDM rubbers is preferably from 0.5 to 50% by weight, in particular from 1 to 8% by weight, based on the total weight of the rubber.

EPM and EPDM rubbers may preferably also be grafted with reactive carboxylic acids or with derivatives of these. Examples include acrylic acid, methacrylic acid and derivatives thereof, e.g. glycidyl(meth)acrylate, and also maleic anhydride.

A further group of preferred rubbers is that of copolymers of ethylene with acrylic acid and/or methacrylic acid and/or with the esters of these acids. The rubbers may additionally comprise dicarboxylic acids such as maleic acid and fumaric acid, or derivatives of these acids, e.g. esters and anhydrides, and/or monomers comprising epoxy groups. These monomers comprising dicarboxylic acid derivatives or comprising epoxy groups are preferably incorporated into the rubber by adding to the monomer mixture monomers comprising dicarboxylic acid groups and/or epoxy groups and having the general formula I, II, Ill or IV

R¹C(COOR²)═C(COOR³)R⁴ (I)

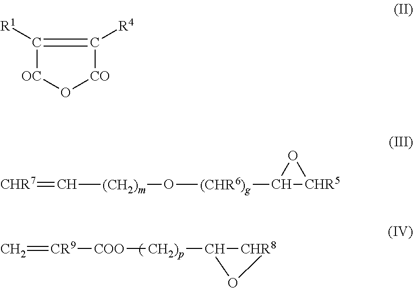

where R¹ to R⁹ are each hydrogen or alkyl groups having from 1 to 6 carbon atoms, and m is an integer from 0 to 20, g is an integer from 0 to 10 and p is an integer from 0 to 5.

The R¹ to R⁹ radicals are preferably each hydrogen, where m is 0 or 1 and g is 1. The corresponding compounds are maleic acid, fumaric acid, maleic anhydride, allyl glycidyl ether and vinyl glycidyl ether.

Preferred compounds of the formulae I, II and IV are maleic acid, maleic anhydride and epoxy group-comprising esters of acrylic acid and/or methacrylic acid, such as glycidyl acrylate and glycidyl methacrylate, and the esters with tertiary alcohols, such as tert-butyl acrylate. Although the latter do not have any free carboxyl groups, their behavior approximates to that of the free acids and they are therefore referred to as monomers with latent carboxyl groups.

The copolymers are advantageously composed of from 50 to 98% by weight of ethylene, from 0.1 to 20% by weight of monomers comprising epoxy groups and/or methacrylic acid and/or monomers comprising acid anhydride groups, the remaining amount being (meth)acrylic esters.

Particular preference is given to copolymers composed of

from 50 to 98% by weight, in particular from 55 to 95% by weight, of ethylene,
from 0.1 to 40% by weight, in particular from 0.3 to 20% by weight, of glycidyl acrylate and/or glycidyl methacrylate, (meth)acrylic acid and/or maleic anhydride, and
from 1 to 45% by weight, in particular from 5 to 40% by weight, of n-butyl acrylate and/or 2-ethylhexyl acrylate.

Further preferred esters of acrylic and/or methacrylic acid are the methyl, ethyl, propyl, isobutyl and tert-butyl esters.

In addition, vinyl esters and vinyl ethers may also be used as comonomers.

The ethylene copolymers described above may be prepared by processes known per se, preferably by random copolymerization under elevated pressure and elevated temperature. Appropriate processes are well known.

Preferred elastomers are also emulsion polymers whose preparation is described, for example, by Blankly in the monograph “Emulsion polymerization”. The emulsifiers and catalysts which can be used are known per se.

In principle, it is possible to use homogeneously structured elastomers or else those with a shell structure. The shell-type structure is determined by the sequence of addition of the individual monomers; the morphology of the polymers is also affected by this sequence of addition.

Monomers which may be mentioned here, merely as examples, for the preparation of the rubber fraction of the elastomers are acrylates, for example n-butyl acrylate and 2-ethylhexyl acrylate, corresponding methacrylates, butadiene and isoprene, and also mixtures thereof. These monomers may be copolymerized with further monomers, for example styrene, acrylonitrile, vinyl ethers and further acrylates or methacrylates, for example methyl methacrylate, methyl acrylate, ethyl acrylate and propyl acrylate.

The soft or rubber phase (with a glass transition temperature of below 0° C.) of the elastomers may be the core, the outer envelope or an intermediate shell (in the case of elastomers whose structure has more than two shells); elastomers having more than one shell may also have more than one shell composed of a rubber phase.

When one or more hard components (with glass transition temperatures above 20° C.) are involved, in addition to the rubber phase, in the structure of the elastomer, they are generally prepared by polymerizing, as principal monomers, styrene, acrylonitrile, methacrylonitrile, α-methylstyrene, p-methylstyrene, acrylic esters or methacrylic esters, such as methyl acrylate, ethyl acrylate or methyl methacrylate. In addition, it is also possible to use smaller proportions of further comonomers.

In some cases, it has been found to be advantageous to use emulsion polymers which have reactive groups at the surface. Examples of such groups are epoxy, carboxyl, latent carboxyl, amino and amide groups, and also functional groups which may be introduced by also using monomers of the general formula

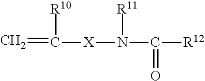

where the substituents may be defined as follows:
R¹⁰ is hydrogen or a C₁-C₄-alkyl group,
R¹¹ is hydrogen, a C₁-C₈-alkyl group or an aryl group, in particular phenyl,
R¹² is hydrogen, a C₁-C₁₀-alkyl group, a C₆-C₁₂-aryl group or —OR¹³
R¹³ is a C₁-C₈-alkyl or C₆-C₁₂-aryl group which may optionally be substituted by O— or N-containing groups,
X is a chemical bond, a C₁-C₁₀-alkylene group or a C₆-C₁₂-arylene group, or

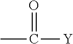

Y is O—Z or NH—Z, and
Z is a C₁-C₁₀-alkylene or C₆-C₁₂-arylene group.

The graft monomers described in EP-A 208 187 are also suitable for introducing reactive groups at the surface.

Further examples include acrylamide, methacrylamide and substituted esters of acrylic acid or methacrylic acid, such as (N-tert-butylamino)ethyl methacrylate, (N,N-dimethylamino)ethyl acrylate, (N,N-dimethylamino)methyl acrylate and (N,N-diethylamino)ethyl acrylate.

The particles of the rubber phase may also be crosslinked. Examples of crosslinking monomers include 1,3-butadiene, divinylbenzene, diallyl phthalate and dihydrodicyclopentadienyl acrylate, and also the compounds described in EP-A 50 265.

It is also possible to use what are known as graft-linking monomers, i.e. monomers having two or more polymerizable double bonds which react at different rates in the polymerization. Preference is given to using such compounds in which at least one reactive group polymerizes at about the same rate as the other monomers, while the other reactive group (or reactive groups), for example, polymerize(s) significantly more slowly. The different polymerization rates give rise to a certain proportion of unsaturated double bonds in the rubber. When a further phase is then grafted onto a rubber of this type, at least some of the double bonds present in the rubber react with the graft monomers to form chemical bonds, i.e. the phase grafted on is joined at least partly to the graft base via chemical bonds.

Examples of such graft-linking monomers are monomers comprising allyl groups, in particular allyl esters of ethylenically unsaturated carboxylic acids, for example allyl acrylate, allyl methacrylate, diallyl maleate, diallyl fumarate, diallyl itaconate, or the corresponding monoallyl compounds of these dicarboxylic acids. In addition, there is a multitude of further suitable graft-linking monomers; for further details, reference is made here, for example, to U.S. Pat. No. 4,148,846.

In general, the proportion of these crosslinking monomers in the impact-modifying polymer is up to 5% by weight, preferably not more than 3% by weight, based on the impact-modifying polymer.

Some preferred emulsion polymers are listed below. Mention should first be made here of graft polymers with a core and with at least one outer shell, and having the following structure:

| Type | Monomers for the core | Monomers for the envelope |
|---|---|---|
| I | 1,3-butadiene, isoprene, | styrene, acrylonitrile, methyl |
| | n-butyl acrylate, ethyl- | methacrylate |
| | hexyl acrylate, or a | |
| | mixture of these | |
| II | as I, but also with use | as I |
| | of crosslinking agents | |
| III | as I or II | n-butyl acrylate, ethyl acrylate, |
| | | methyl acrylate, 1,3-butadiene, |
| | | isoprene, ethylhexyl acrylate |
| IV | as I or II | as I or III, but also with use of |
| | | monomers having reactive groups, |
| | | as described herein |
| V | styrene, acrylonitrile, | first envelope composed of |
| | methyl methacrylate, | monomers as described under I |
| | or a mixture of these | and II for the core |
| | | second envelope as described |
| | | under I or IV for the envelope |

Instead of graft polymers whose structure has more than one shell, it is also possible to use homogeneous, i.e. single-shell, elastomers composed of 1,3-butadiene, isoprene and n-butyl acrylate or their copolymers. These products too may be prepared by also using crosslinking monomers or monomers having reactive groups.

Examples of preferred emulsion polymers are n-butyl acrylate/(meth)acrylic acid copolymers, n-butyl acrylate/glycidyl acrylate or n-butyl acrylate/glycidyl methacrylate copolymers, graft polymers with an inner core composed of n-butyl acrylate or based on butadiene and with an outer envelope composed of the aforementioned copolymers, and copolymers of ethylene with comonomers which supply reactive groups.

The elastomers described may also be prepared by other conventional processes, for example by suspension polymerization.

Preference is likewise given to silicone rubbers, as described in DE-A 37 25 576, EP-A 235 690, DE-A 38 00 603 and EP-A 319 290.

It is of course also possible to use mixtures of the types of rubber listed above.

As component G), the inventive thermoplastic molding compositions may comprise the usual processing assistants, such as stabilizers, oxidation retarders, agents to counteract thermal decomposition and decomposition by ultraviolet light, lubricants and mold-release agents, colorants such as dyes and pigments, nucleating agents, plasticizers, flame retardants, etc.

Examples of oxidation retarders and thermal stabilizers include sterically hindered phenols and/or phosphites and amines (e.g. TAD), hydroquinones, aromatic secondary amines such as diphenylamines, various substituted representatives of these groups, and mixtures thereof in concentrations of up to 1% by weight, based on the weight of the thermoplastic molding compositions.

UV stabilizers, which are used generally in amounts of up to 2% by weight based on the molding composition, include various substituted resorcinols, salicylates, benzotriazoles and benzophenones.

It is possible to add inorganic pigments such as titanium dioxide, ultramarine blue, iron oxide and carbon black, and also organic pigments such as phthalocyanines, quinacridones and perylenes, and also dyes such as anthraquinones as colorants.

Nucleating agents which may be used are sodium phenylphosphinate, alumina, silica, and preferably talc.

The inventive thermoplastic molding compositions may be prepared by methods known per se, by mixing the starting components in conventional mixing apparatus, such as screw extruders, Bartender mixers or Banbury mixers, and then extruding them. After the extrusion, the extrudate may be cooled and comminuted. It is also possible to premix individual components and then to add the remaining starting materials individually and/or likewise in a mixture. The mixing temperatures are generally from 230 to 320° C.

In a further preferred method, components B) to F) and, if appropriate, G) may be mixed with a prepolymer, compounded and granulated. The resulting granule is subsequently condensed in the solid phase under an inert gas, continuously or batchwise, at a temperature below the melting point of component A) up to the desired viscosity.

The inventive thermoplastic molding compositions feature good flowability with simultaneously good processability, and also distinctly improved seal seam strength and thermal stability.

They are suitable for producing fibers, films and moldings of any type. Some examples are specified in the following: cylinder head covers, motorcycle covers, intake tubes, charge-air cooler caps, plug connectors, gearwheels, cooling fan wheels, cooling water vessels.

Electrical and electronic applications which can be produced using improved-flow polyamides are plugs, plug components, plug connectors, cable harness components, cable mounts, cable mount components, three-dimensionally injection-molded cable mounts, electrical connector elements, mechatronic components.

Possible uses in automobile interiors are for dashboards, steering column switches, seat components, headrests, center consoles, gearbox components and door modules, and possible automobile exterior components are door handles, exterior mirror components, windshield wiper components, windshield wiper protective casings, grilles, roof rails, sunroof frames, engine hoods, cylinder head covers, intake tubes (especially intake manifolds), windshield wipers and exterior bodywork parts.

Possible uses of improved-flow polyamides in the kitchen and household sector are for production of components for kitchen equipment, for example fryers, smoothing irons, buttons, and also garden and leisure sector applications, for example components for irrigation systems or garden equipment and door handles.

### EXAMPLES

The following components were used:

Component A:

Nylon-6 (polycaprolactam) having a viscosity number VN of 200 ml/g, measured as a 0.5% by weight solution in 96% by weight sulfuric acid at 25° C. to ISO 307 (Ultramid® from BASF SE was used).

### B) Polyethyleneimines

TABLE 1

| Lupasol ® | G20 | G100 | WF | SK |
|---|---|---|---|---|
| M_{w} | 1 300 | 5 000 | 25 000 | 2 000 000 |
| Prim/sec/tert | 1/0.91/0.64 | 1/1.05/0.76 | 1/1.20/0.76 | 1/1.16/1.19 |
| amines | | | | |

Lupasol® \hat{=} registered brand of BASF SE

The ratio of primary/secondary/tertiary amines was determined by means of ¹³C NMR spectroscopy.

C) Calcium montanate
D) Cul/Kl in a ratio of 1:4 (80% batch in PA 6)
E) Glass fibers
F) Nigrosine (Nigrosine SA PL from Orient Chemical)

The molding compositions were prepared in a ZSK 40 at a throughput of 50 kg/h and flat temperature profile at approx. 260° C.

The components B) (see table) were metered in in zone 0, 5 or 3.

The following measurements were carried out:

Tensile test to ISO 527, mechanical characteristic values before and after heat storage at 200° C. in a forced-air oven

VN: c=5 g/l in 96% sulfuric acid, to ISO 307
MVR: 275° C., 5 kg, 4 min, to ISO 1133
Flow spiral: 280° C./70° C. 1000 bar, 2 mm

To test the weld line strength, a tensile test (ISO 527-2) and a bending test were carried out after vibration welding and after heat storage at 180° C. for 300 h, 500 h and 1000 h:

Specimen

| | |
|---|---|
| Mold | P1 0/4.0 plaques (110 mm × 110mm × 4 mm) |
| Joint area | 440 mm² |
| Conditioning before | |
| welding | drying: 80° C./24 h, reduced pressure |
| testing | drying: 80° C./24 h, reduced pressure |

Welding tests

| | |
|---|---|
| Welding | linear, butt, same type |
| Welding distance | 1.5 mm |
| Welds per setting | 8 |

Machine data

| | |
|---|---|
| Vibration welding | Branson (M-102 H) |
| machine | |
| Welding frequency | approx. 240 Hz |
| Welding | linear |
| Welding pressure | approx. 1.6 MPa |
| Amplitude | 0.9 mm |

The results of the tests and compositions of the molding compositions are listed in Tables 2 to 5.

TABLE 2

| | Component A | Component | Component B | Component C | Component D | Component E | Component F |
|---|---|---|---|---|---|---|---|
| | [% by wt.] | B | [% by wt.] | [% by wt.] | [% by wt.] | [% by wt.] | [% by wt.] |
| Comp. 1 | 67.65 | — | 0 | 0.2 | 0.7 | 30 | 0.75 |
| Comp. 2 | 67.15 | SK | 0.5 Zone 5 | 0.2 | 0.7 | 30 | 0.75 |
| pomp. 3 | 66.65 | G20 | 1.0 Zone 5 | 0.2 | 0.7 | 30 | 0.75 |
| Ex. 1 | 67.85 | G20 | 0.5 Zone 5 | 0.2 | 0.7 | 30 | 0.75 |
| Ex. 2 | 67.85 | G100 | 0.5 Zone 5 | 0.2 | 0.7 | 30 | 0.75 |
| Ex. 3 | 67.85 | WF | 0.5 Zone 5 | 0.2 | 0.7 | 30 | 0.75 |
| Ex. 4 | 67.15 | G20 | 0.5 Zone 5 | 0.2 | 1.4 | 30 | 0.75 |
| Ex. 5 | 67.15 | G20 | 0.5 Zone 0 | 0.2 | 1.4 | 30 | 0.75 |
| Ex. 6 | 67.15 | G20 | 0.5 Zone 3 | 0.2 | 1.4 | 30 | 0.75 |

TABLE 3

| | VN | | | | | | |
|---|---|---|---|---|---|---|---|
| | [ml/g] | | | | | Flow | |
| | After | After | 500 h | 1000 h | 300 h | sprial | MVR |
| | comp. | welding | 160° C. | 160° C. | 180° C. | [cm] | [ml/10 min] |
| Comp. 1 | 202 | — | — | — | — | 24 | 17 |
| Comp. 2 | 194 | 180 | 262 | 293 | — | 26 | 21 |
| Comp. 3 | 159 | 127 | 202 | 162 | 166 | 46 | 74 |
| Ex. 1 | 170 | 151 | 188 | 204 | 232 | 38 | 31 |
| Ex. 2 | 185 | 169 | 238 | 252 | 298 | 33 | 31 |
| Ex. 3 | 194 | 175 | 240 | — | 304 | 32 | 26 |
| Ex. 4 | 170 | 147 | 185 | 200 | 209 | 39 | 50 |
| Ex. 5 | 171 | 131 | 183 | 196 | 199 | 40 | 47 |
| Ex. 6 | 185 | 169 | 238 | 252 | 298 | 33 | 31 |

TABLE 4

| | Impact strength | Elongation at | Modulus of | |
|---|---|---|---|---|
| | unnotched | break | elasticity | Yield stress |
| | [kJ/m2] | [%] | [GPa] | [MPa] |
| Comp. 1 | — | — | — | — |
| Comp. 2 | 95 | 3.4 | 9700 | 173 |
| Comp. 3 | 78 | 3.1 | 9590 | 171 |
| Ex. 1 | 81 | 3.1 | 10020 | 175 |
| Ex. 2 | 82 | 3.3 | 9540 | 172 |
| Ex. 3 | 92 | 3.3 | 9940 | 175 |
| Ex. 4 | 82 | 3.4 | 9630 | 174 |
| Ex. 5 | 85 | 3.2 | 9740 | 175 |
| Ex. 6 | 76 | 3.2 | 9680 | 174 |

TABLE 5

| | Weld line strength [MPa] | | | | Flexural strength [MPa] | | | |
|---|---|---|---|---|---|---|---|---|
| | | 500 h | 1000 h | 300 h | | 500 h | 1000 h | 300 h |
| | 0 | 160° C. | 160° C. | 180° C. | 0 | 160° C. | 160° C. | 180° C. |
| Comp. 1 | — | — | — | — | — | — | — | — |
| Comp. 2 | 91 | 61 | 70 | 59 | 178 | 131 | 115 | 166 |
| Comp. 3 | 71 | 63 | 62 | 66 | 120 | 118 | 115 | 130 |
| Ex. 1 | 80 | 52 | 67 | 72 | 142 | 123 | 136 | 135 |
| Ex. 2 | 93 | 60 | 76 | 72 | 179 | 129 | 154 | 160 |
| Ex. 3 | 93 | 55 | 63 | 63 | 178 | 119 | 157 | 159 |
| Ex. 4 | 76 | 51 | 59 | 70 | 133 | — | 111 | 122 |
| Ex. 5 | 84 | 56 | 63 | 72 | 150 | 120 | 124 | 136 |
| Ex. 6 | 83 | 56 | 61 | 72 | 146 | 114 | 110 | 131 |

What is claimed is:

1. A thermoplastic molding composition comprising
A) from 10 to 98.7% by weight of at least one thermoplastic polyimide having a viscosity number (VN) to ISO 307 of at least 150 ml/g,
B) from 1 ppm to 0.95% by weight of at least one polyethyleneimine homo- or copolymer,
C) from 0.05 to 3% by weight of a lubricant,
D) from 0.05 to 3% by weight of a copper-containing stabilizer,
E) from 1 to 50% by weight of a fibrous or particulate filler, or mixtures thereof,
F) from 0.1 to 5% by weight of a nigrosine,
G) from 0 to 30% by weight of further additives,
the sum of components A) to G) adding up to 100%.

2. The thermoplastic molding composition according to claim 1, in which component B) is a branched polyethyleneimine polymer.

3. The thermoplastic molding composition according to claim 1 or 2, in which component B) has a ratio of primary/secondary/tertiary amines of from 1/0.7-1.4/0.3-1.1 to 1/0.8-1.3/0.5-0.9.

4. The thermoplastic molding composition according to claims 1 to 3, in which component B) has a molecular weight (M_{W}) of from 100 to 3 000 000.

5. The thermoplastic molding composition according to claims 1 to 4, in which component C) is composed of aluminum salts, alkali metal salts, alkaline earth metal salts, esters or amides, of fatty acids having from 10 to 44 carbon atoms.

6. The thermoplastic molding composition according to claims 1 to 5, in which component C) is composed of calcium salts of fatty acids having from 10 to 44 carbon atoms.

7. The thermoplastic molding composition according to claims 1 to 6, in which the copper-containing stabilizer D) is a copper halide.

8. The thermoplastic molding composition according to claims 1 to 7, in which D) is composed of Cul:Kl in a ratio of 1:4.

9. The use of the thermoplastic molding compositions according to claims 1 to 8 for producing fibers, films and moldings of any type.

10. A fiber, film or molding of any type, obtainable from the thermoplastic molding compositions according to claims 1 to 8.

11. The molding according to claim 10, which is used as an intake tube (intake manifold) in the vehicles sector.
